(19) United States
(12) Patent Application Publication
(10) Pub. No.: US 2023/0304491 A1
(43) Pub. Date: Sep. 28, 2023

(54) PARTICLE DAMPER FOR ELECTRIC SUBMERSIBLE PUMPS

(71) Applicant: Baker Hughes Oilfield Operations, LLC, Houston, TX (US)

(72) Inventor: Ameen Roshdy, Tulsa, OK (US)

(21) Appl. No.: 18/190,395

(22) Filed: Mar. 27, 2023

Related U.S. Application Data
(60) Provisional application No. 63/324,533, filed on Mar. 28, 2022.

(51) Int. Cl. F04B 47/06; E21B 43/12; F04B 39/00; F04B 17/03; F16F 7/01

(52) U.S. Cl. CPC F04B 47/06; E21B 43/128; F04B 17/03; F04B 39/0044; F16F 7/015

(57) ABSTRACT

Systems and methods for reducing vibration in downhole tools using particle dampers. In one embodiment, an ESP system has components including at least a pump and a motor. The motor is coupled to the pump and is configured to drive the pump to pump fluid from a well. The ESP system also includes a particle damping unit which is mechanically coupled to at least one of the ESP components. The particle damping unit has one or more compartments, each of which contains a collection of particles that are loose within the corresponding compartment. Vibration in the ESP components causes movement of the particles within the compartments of the particle damping units, and the movement of the particles dissipates the vibrational energy, causing damping of the vibration.

### BACKGROUND

### Field of the Invention

The invention relates generally to vibration damping, and more particularly to systems and methods for reducing vibration in electric submersible pumps.

### Related Art

Oil is commonly produced from wells by positioning electric submersible pumps (ESPs) in the wells and driving the pumps to lift the oil out of the wells. The environment downhole in the well is very harsh, and it is important to ensure that the equipment installed in the well is as reliable as possible in order to avoid the expense of having to pull the equipment from the well and replace or repair it. Downhole equipment it is therefore tested in a variety of ways in an effort to ensure that it is working reliably and will not fail after it has been installed.

One of the indicators of reliability is the level of vibration exhibited in an ESP motor, so customers focus on vibration, not only in operation, but also in testing. Vibration testing which is performed on downhole equipment such as ESPs typically includes both factory acceptance tests (FATs) and system integration tests (SITs). The standards for both factory acceptance tests and system integration tests are set by the American Petroleum Institute.

Factory acceptance testing is performed on components of the ESP system prior to installation of the system in the well. Thus, components of the ESP such as the pump and the motor which drives the pump are tested in the factory to determine the level of vibration in these components when they are operated. If the components fail the factory acceptance tests, they may, for example, be repaired, reworked or scrapped. If the components pass the factory acceptance tests, they are assembled to form the ESP system, which can then be installed in the well.

System integration testing is performed on the assembled ESP system. The assembled system (commonly including a motor section, a pump section and a seal section between them) is connected to piping or tubing, and this assembly is lowered into a well (not necessarily the well in which it will ultimately be installed and operated). the ESP system is then operated in a closed loop to simulate the way it will be operated when it is ultimately installed in a well and operated by a customer.

System integration testing is a fairly expensive test because the ESP has to be assembled and all the associated systems must be connected to it. The testing commonly takes several days. ESP systems fail one or more aspects of the system integration testing on a relatively frequent basis. These failures incur a great deal of expense because of the time and effort involved in assembling, operating and testing the system. The failure of a system integration test may, for example, cost an estimated $80,000. Testing failures may also create a great deal of embarrassment for the manufacturer of the ESP when a system fails in front of a customer, and can result in the loss of a contract for the ESP system, particularly in a competitive environment. Following a failure in system integration testing, it may be necessary to pull the ESP system out of the well, disassemble the ESP components such as pump and/or motor, rework these components, and re-perform factory acceptance testing, as well as system integration testing.

It is therefore important to find ways to reduce vibration in ESP systems, not only because of the effect of vibration on the reliability of these systems in operation in the field, but also because of the expense associated with failures of factory acceptance tests and system integration tests. consequently, it would be desirable to provide systems and methods for reducing vibration in ESP systems.

### SUMMARY

These problems are addressed by embodiments disclosed herein which use particle dampers that are secured to, or are incorporated into, downhole equipment such as ESP systems to reduce vibrations. The particle dampers comprise containers or compartments that contain a collection of particles. The particles are constrained to move within the compartment, and they dissipate the vibrational energy of the container or a piece of equipment to which the compartment is affixed. The energy is dissipated through a combination of impacts between the particles, impacts between the particles and the container, friction between the particles, and friction between the particles and the container.

In one example embodiment, an ESP system has components including at least a pump and a motor. The motor is coupled to the pump and is configured to drive the pump to pump fluid from a well. The ESP system also includes a particle damping unit which is mechanically coupled to at least one of the ESP components. The particle damping unit has one or more compartments, each of which contains a collection of particles that are loose within the corresponding compartment. Vibration in the ESP components causes movement of the particles within the compartments of the particle damping units, and the movement of the particles dissipates the vibrational energy, causing damping of the vibration.

In some embodiments, the particle damping unit comprises a separate, stand-alone unit from the pump and the motor. This separate unit may be secured to the exterior (e.g., housing) of either the pump or the motor. The damping unit may, in some embodiments, be secured to the lower end of the housing of the motor, or the damping unit may have an annular shape, where the unit is positioned around a production pipe at the upper end of the housing of the pump and is secured to the pump housing. In some embodiments, the damping unit has an annular shape and is secured between two of the ESP components, where a shaft of at least one of the ESP components extends through the central aperture of the annular damping unit.

In some embodiments, the particle damping unit is integrally formed with one of the ESP components. For example, the compartments may be formed within the body of the one of the ESP components, such as within a stator body of the motor, within a motor head of the motor, or within a wall of a pump body of the pump.

One alternative embodiment comprises an apparatus for reducing vibration in a downhole tool. The apparatus is a particle damper which includes one or more compartments, each of which is in fixed relation to the downhole tool. Each compartment contains a corresponding collection of particles which are capable of freely moving within the compartment so that vibration in the downhole tool causes the particles to move in the compartments and dissipate the vibrational energy to damp the vibration. The particle damper may comprise a stand-alone unit which is secured to an exterior of the downhole tool, or it may be integrally formed within a component of the downhole tool.

Another alternative embodiment comprises a method for reducing vibration in a downhole tool. In this method, compartments are provided in fixed relation to a component of a downhole tool. Particles are then placed in the compartments, where they are loose and can move within the compartments, and the particles are sealed in the compartments. The downhole tool is then operated, where vibrations in the downhole tool cause movement of the particles within the compartments, and the movement of the particles causes damping of the vibrations.

In some embodiments, the compartments are provided by forming the compartments integrally within the component of the downhole tool and assembling the component into the downhole tool. In some embodiments, the downhole tool may be installed in a well and the tool is operated in the well. In some embodiments, the compartments may be formed in a stand-alone particle damper unit, and the stand-alone particle damper unit is then to the exterior of the downhole tool. In both integral and stand-alone embodiments, the downhole tool may be an ESP component.

### BRIEF DESCRIPTION OF THE DRAWINGS

Other objects and advantages of the invention may become apparent upon reading the following detailed description and upon reference to the accompanying drawings.

FIG. 1 is a diagram illustrating the structure of an ESP motor.

FIG. 2 is a diagram illustrating an ESP system installed in a well.

FIG. 3 is an example embodiment in which a particle damping component is coupled to an ESP in accordance with some embodiments.

FIG. 4 is a simple diagram illustrating a particle damping unit in accordance with some embodiments.

FIG. 5 is a diagram illustrating a particle damping unit having multiple separate particle damping components in accordance with some embodiments.

FIG. 6 is a diagram illustrating a particle damping unit secured to the upper end of an ESP in accordance with some embodiments.

FIG. 7 is a diagram illustrating a particle damping unit secured between sections of an ESP in accordance with some embodiments.

FIG. 8 is a cross-sectional view of a portion of an ESP’s pump with integral particle damping elements in accordance with some embodiments.

FIG. 9 is a diagram illustrating a gas separator having integral particle dampers in accordance with some embodiments.

FIG. 10 is a diagram illustrating a motor head having integral particle dampers in accordance with some embodiments.

FIG. 11 is a diagram illustrating a stator having integral particle dampers in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for reducing vibrations in an ESP system using particle dampers that may either be separate components that are secured to the ESP or integral components that are incorporated into the design of the ESP. “Separate” is used here to refer to particle dampers that are self-contained, stand-alone units that are external to a tool or system and are secured to an exterior surface or housing of the tool or system, rather than sharing structural elements with the ESP (including the motor, pump, seal, or other ESP components). “Integral” refers to embodiments of the particle dampers that share structural elements (e.g., where the motor head, diffuser body, or other element of the ESP forms the compartment in which the particles of the particle dampers are contained).

Because vibration is caused by the rotation of elements within the ESP system components, vibration has conventionally been addressed in terms of rotordynamic phenomena, rather than the structural behavior of the ESP system. Rotordynamic phenomena concern the rotating elements of the ESP components such as the shaft and rotor stack within the motor section, or the shaft and impeller stack within the pump section. Structural behavior of the system is more focused on static structural elements, such as the stator of the motor section or the body of the pump section. Structural behavior of the ESP also concerns the overall or externally visible behavior of the system, such as the vibration movement of the component housings as a result of the vibration caused by the internally rotating elements. Although the rotordynamic phenomena do contribute to the excitation of the system as evident by the synchronous response of the system during testing, they do not contribute significantly to the dynamic structural characteristics of the system (modes, mode shapes and damping) as measured in a modal testing, for example.

The embodiments of the invention disclosed herein are designed to address the structural behavior of the ESP, rather than the rotordynamic phenomena that are conventionally addressed to reduce vibration in rotating machines. These embodiments focus on the structural behavior rather than the rotor dynamic behavior of the ESP system because the rotating shaft and rotor stacks are not accessible for measurement, so the only available vibration measurements are those made externally on the motor housing. The vibration levels measured externally on the housing have less to do with bearing design, and more to do with factors such as distribution of mass, stiffness and damping elements in the ESP structure. Thus, the present embodiments address structural vibration.

Embodiments disclosed herein address the structural behavior of the ESP by introducing damping elements in the ESP structure. More specifically, these embodiments use particle dampers to reduce vibration exhibited by the ESP system. The damping elements may be self-contained components of the ESP that are separate from other components such as the pump and motor, or the damping elements may be formed integrally within the other components.

Generally, particle dampers use a collection of particles that are constrained to move within a container in order to dissipate the energy of the container’s movement. The energy is dissipated through a combination of impacts between the particles, impacts between the particles and the container, friction between the particles, and friction between the particles and the container. In the present embodiments, the containers of one or more particle dampers are either affixed to or embedded within (e.g., formed within) one or more components of the ESP system in order to dissipate the vibrational energy of the ESP. Example embodiments are discussed in detail below.

It should also be noted that embodiments disclosed herein are not limited to ESP applications. Various other downhole tools and systems may use motors or other mechanisms that are subject to vibrations and may therefore benefit from the implementation of particle dampers to reduce the levels of vibration that are experienced by these tools and systems. Such tools and systems may use separate particle damper units that are secured to the tools and systems, or they may have integral particle dampers that are formed within, or as part of, the components of these tools and systems.

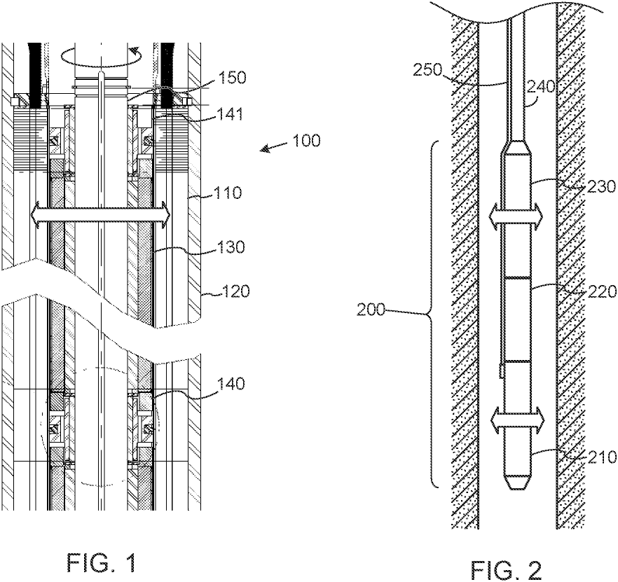

Before describing embodiments of the present invention, it may be helpful to briefly discuss the general structure of the ESP and the sources of the vibration. Referring to FIG. 1, a diagram illustrating the structure of an ESP motor is shown.

As depicted in this figure, motor 100 has a stator 110 which is installed within a housing 120. These elements of the motor are fixed and, aside from movement due to such factors as vibration, are static (i.e., they do not move). Stator 110 is generally cylindrical and has a bore through its center which is coaxial with the cylindrical shape of the stator. A rotor 130 is positioned in the bore of the stator. The rotor is held in place by bearings (e.g., 140, 141) that are positioned along the length of the rotor and at the ends of the rotor. The bearings allow rotor 130 to rotate freely within the bore of stator 110. Rotor 130 is secured to a shaft 150 so that when the rotor rotates in the bore, it causes the shaft to rotate as well. As indicated by the double arrow in the figure, imbalances in the rotor or other irregularities can cause the rotor to vibrate within the bore of the stator. The vibration is transferred through the bearings to the fixed structure of the motor (i.e., the stator and housing). It is this vibration of the fixed structure that is exhibited by the motor and evident during testing of the motor.

It should be noted that only a portion of the motor structure is illustrated in FIG. 1 for purposes of describing the vibration of the motor. ESP motors may have a variety of additional features which are not shown in the figure. The general structure and operation of the motor and the resulting vibration is nevertheless the same.

Referring to FIG. 2, a diagram illustrating an ESP system installed in a well (e.g., for system integration testing or actual operation) is shown. ESP 200 includes a motor section 210, a seal section 220 and a pump section 230. ESP 200 is connected to a pipe 240 through which oil is pumped to the surface of the well. A power cable 250 extends from a drive unit at the surface of the well to motor section 210 of the ESP.

Power that is provided from the drive unit to motor section 210 via power cable 250 drives the motor, which in turn rotates a shaft that extends to pump 230 and drives the pump. As motor section 210 is operated, the rotor spinning within the motor generates vibration which causes the entire motor section to vibrate laterally with respect to the axis of the drive shaft. This is indicated by the double-ended arrow over the motor section in the figure. Other components of ESP 200 which have rotating elements (e.g., a pump section, with its rotating impellers, or a gas separator, which has a rotating impeller or auger) may also generate vibrations (as indicated in the figure by the corresponding arrow) which contribute to the overall vibration of the ESP. Particle damping components are therefore added to the ESP system in order to dissipate some of the vibrational energy.

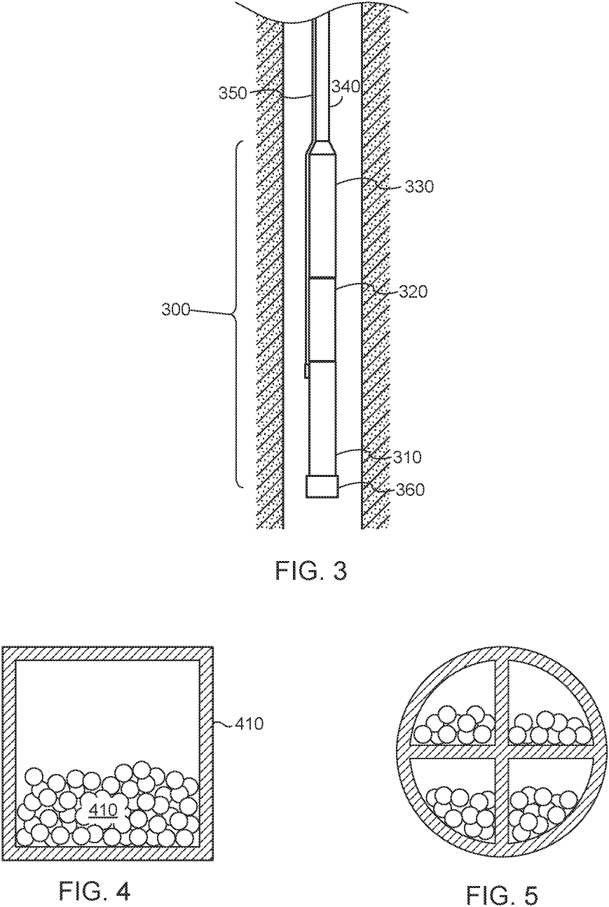

Referring to FIG. 3, an example embodiment in which a particle damping component is coupled to an ESP is shown. In this example, ESP 300 has the same major components as ESP 200 of FIG. 2: a motor section 310, a seal section 320 and a pump section 330. ESP 300 is connected to a pipe 340, which suspends the ESP in the well. Power cable 350 couples motor section 310 to a drive unit at the surface of the well.

In addition to these components, ESP 300 includes a particle damping unit 360. Particle damping unit 360 is secured to the lower end of motor section 310. Particle damping unit 360 does not move with respect to the motor section, but is instead fixed to the motor section housing. Particle damping unit 360 has one or more compartments therein which are partially filled with particles such as lead or steel shot (round pellets). As ESP 300 (including motor section 310) moves back and forth due to the vibration of components such as the motor and pump, the particles within the compartment(s) in the particle damping unit move. This causes the particles to impact and roll or rub against the other particles in the compartment, which dissipates a portion of the vibrational energy and reduces the measurable vibration of the ESP structure.

Referring to FIG. 4, a simple diagram illustrating the particles within a compartment (e.g., of the particle damping unit) in accordance with some embodiments is shown. as depicted in this figure, the compartment 410 is simply a rectangular box which is approximately half filled with spherical particles 420. As compartment 410 is vibrated (e.g., to the left and right in the figure), the walls of the compartment push the collection of particles 420 back and forth. From the perspective of compartment 410, particles 420 move back and forth within the compartment. The impacts and friction between the particles (and to some extent the compartment) causes energy to be dissipated.

Although the example of FIG. 4 uses a simple rectangular compartment, it should be noted that the shape and size of the compartment may vary. Referring to FIG. 5, a diagram illustrating a particle damping unit having four separate pie-shaped compartments is shown. This could, for example, be a cross-section (viewed from the top) of a cylindrical damping unit that might be secured to the bottom of an ESP motor as shown in FIG. 3. Even though the particle damping unit is positioned at the lower end of the ESP assembly, it nevertheless reduces the overall vibration of the ESP.

One of the advantages of securing the particle damping unit to the lower end of the ESP is that it is very easy to do - the unit is simply secured to the lower end of the ESP (e.g., By bolting or welding the particle damping unit to the lower end of the motor housing). This does not require any redesign of the ESP. The particle damping unit itself is also very simple. The unit has no moving parts other than the particles which are loose and are allowed to move freely within the compartment in which they are contained, and is not affected by temperature. The particle damping unit may also be designed so that it is a very inexpensive addition to the ESP system. The particle damping unit can be designed so that the particles and the compartment in which they are contained is isolated from any fluid communication with the rest of the ESP system.

While the particle damping unit can, in some embodiments, simply be attached to the lower end of the ESP as shown in FIG. 3, it may also be positioned at other locations in the ESP assembly. It may be desirable to change the position of the particle damping unit because the ESP structure is very flexible due to its length-to-diameter ratio and the fact that it is supported only from one location hanging vertically in the well. These factors result in a “beam” structure that has multiple vibration modes in the operating range. The mass and the location of the particle damper are also important to the design of the particle damping system. Careful design of the system will push modes away from running speed in addition to providing general damping to the system. Further, the modes of vibration of the ESP structure have corresponding nodes and antinodes, where the amplitude of the vibration is minimal at the nodes and is highest at the antinodes. In some embodiments, the particle dampers are positioned at the antinodes so that their effect is maximized (i.e., the extent of the vibration damping is maximized).

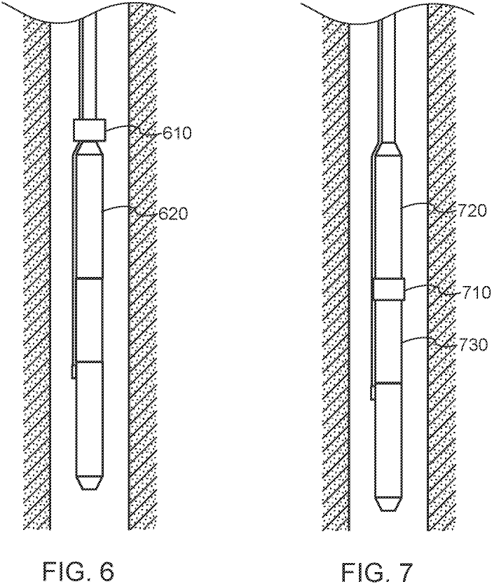

FIGS. 6 and 7 provide examples of several alternative positions of a damping unit which may affect the vibration modes of the ESP system. The use of multiple damping units or components may also affect the vibration modes.

One example of an alternative position of a particle damping unit is shown in FIG. 6. In this figure, particle damping unit 610 is secured to the upper end of the ESP (i.e., at the upper end of pump section 620). As depicted in the alternative embodiment of FIG. 7, particle damping unit 710 is positioned between pump section 720 and seal section 730. Vertical damping units 610 and 710 would, of course, have to be designed to accommodate the other components of the ESP system. For example, Damping unit 610 would need to have an annular shape so that it could be positioned around the pipe secured to the upper end of the ESP. Similarly, damping unit 710 would need to be annular so that the shaft extending from the motor section to the pump section could pass through the central aperture through the annular unit.

These annular particle damping units would be more expensive then the simpler unit which is positioned at the bottom of the ESP, but they could be preferred in some embodiments in order to provide particle damping at different positions in the ESP assembly. These different positions may be preferable in some instances to provide damping of specific modes of vibration in the ESP.

In addition to the use of separate particle damping units that are secured to the ESP, some embodiments may involve the incorporation of particle damping components into the designs of existing components of the ESP. For example, particle damping components could be designed into the motor head, motor housing or even the stator of the ESP motor section. Similarly, particle damping components could be integrated into the body of the ESP’s pump section.

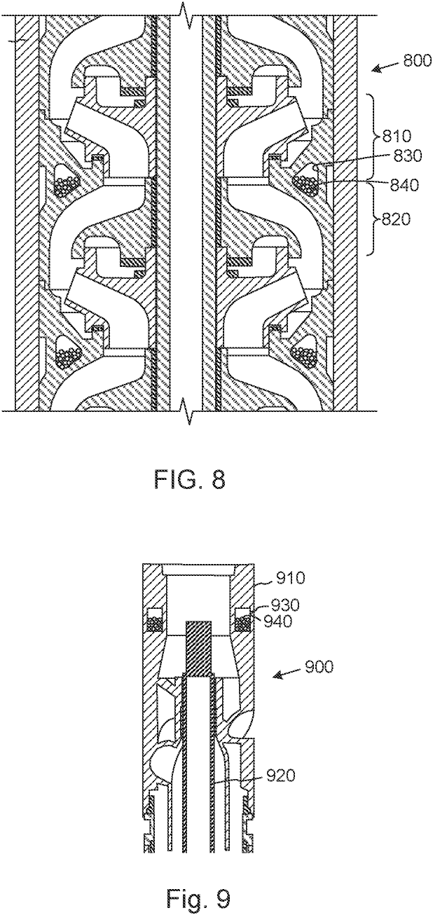

Referring to FIG. 8, a cross-sectional view of a portion of an ESP’s pump is shown. Pump section 800 has multiple stages of impellers (e.g., 810) and diffusers (e.g., 820). A particle damping compartment 830 is formed in the diffuser. This compartment, for example, could be included in casting or could be manufactured by 3D printing technologies. Particle damping compartment 830 is partially filled with particles 840 to form a particle damping component of the pump. As depicted in the figure, there are multiple such particle damping components integrated into the body of the pump. As noted above, the number, size, shape, placement and other characteristics of the particle damping components may vary from one embodiment to another.

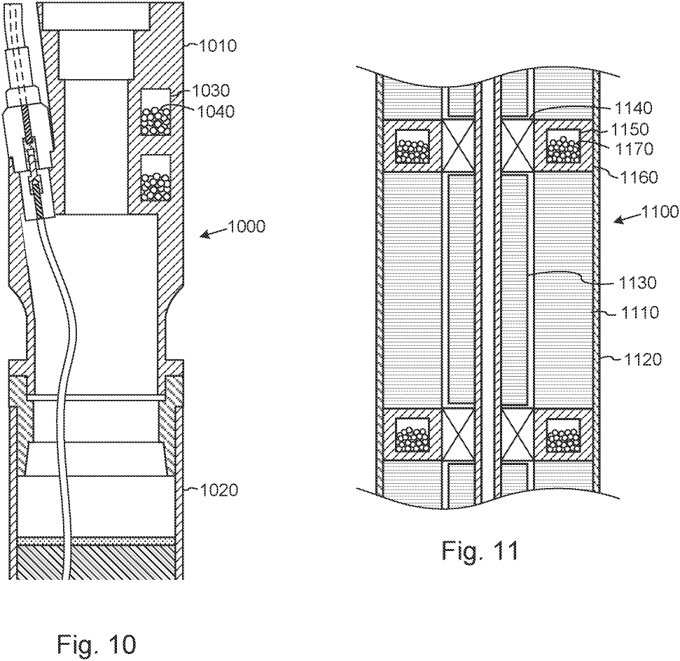

FIGS. 9-11 show additional examples of ESP components that have particle dampers integrally formed within them. FIG. 9 is a diagram illustrating a gas separator having integral particle dampers, FIG. 10 is a diagram illustrating a motor head having integral particle dampers, and FIG. 11 is a diagram illustrating a stator having integral particle dampers.

Referring to FIG. 9, an upper end of a gas separator 900 is shown. Gas separator 900 has a body 910. An impeller shaft 920 extends through body 910. Impeller shaft 920 has a set of impeller blades (not shown) attached to it so that rotation of the shaft drives the impeller blades to separate gasses from liquids that flow through the separator. Body 910 of the gas separator has a set of particle damper compartments (e.g., 930) formed in its outer wall. Particles 940 fill a portion of the volume of compartment 930. A portion of compartment 930 is unfilled so that particles 940 can move within the compartment when body 910 vibrates.

Referring to FIG. 10, a motor head 1010 of an ESP motor section 1000 is illustrated. Motor head 1010 is attached to the upper end of a motor housing 1020. In this embodiment, a set of particle damper compartments (e.g., 1030) are formed within a side wall of motor head 1010. As in the other embodiments described herein, particles 1040 fill a portion of the volume of each compartment 1030, while a portion of the compartment is unfilled. This allows particles 1040 to move within the compartment when motor head 1010 vibrates, thereby dissipating the vibrational energy experienced by the motor.

Referring to FIG. 11, a portion of an ESP motor having particle dampers integrated into the stator is illustrated. In this embodiment, motor 1100 has a stator body with a set of stacked laminations 1110 pressed into a housing 1120. A set of stator windings (not shown) are positioned in slots within the stacked laminations, where the energized windings generate magnetic fields that drive a rotor 1130. Rotor 1130 comprises a set of stacked laminations mounted on a motor shaft, with a set of permanent magnets mounted in the stacked laminations.

A set of bearings (e.g., 1140) hold the motor shaft and rotor coaxially within a bore of the stator body, allowing the shaft and rotor to rotate within the bore. In this embodiment, a set of particle dampers are mounted in the stator between housing 1120 and bearings 1140. The particle dampers comprise a compartment (e.g., 1150) formed within a particle damper body (e.g., 1160). Particles 1170 fill a portion of the volume of each compartment 1150, while the remaining portion of the compartment is unfilled, so that the particles can move within the compartment in response to vibration of the stator body. Movement of particles 1170 within compartments 1150 dissipates the vibrational energy experienced by the stator body.

The foregoing embodiments are intended to be illustrative of the invention rather than limiting, and alternative embodiments may use means other than those described above to implement the functionality of the particle damping components.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the described embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed by the claims of the application.

What is claimed is:

1. An electric submersible pump (ESP) system comprising:
ESP components including at least
a pump, and
a motor coupled to the pump and configured to drive the pump to pump fluid from a well; and
a particle damping unit mechanically coupled to at least one of the ESP components;
wherein the particle damping unit comprises one or more compartments, each of the compartments containing a collection of particles, each of the particles being loose within the corresponding compartment; and
wherein vibration in the at least one of the ESP components causes movement of the particles within the compartments of the particle damping unit, the movement of the particles causing damping of the vibration.

2. The ESP system of claim 1, wherein the particle damping unit comprises a separate unit from the pump and the motor.

3. The ESP system of claim 2, wherein the damping unit is secured to an exterior of either the pump or the motor.

4. The ESP system of claim 3, wherein the damping unit is secured to a lower end of a housing of the motor.

5. The ESP system of claim 3, wherein the damping unit has an annular shape, the damping unit positioned around a production pipe and secured to an upper end of a housing of the pump.

6. The ESP system of claim 3, wherein the damping unit has an annular shape, the damping unit secured between two of the ESP components, wherein a shaft of at least one of the ESP components extends through a central aperture of the damping unit.

7. The ESP system of claim 1, wherein the particle damping unit is integrally formed with one of the ESP components.

8. The ESP system of claim 7, wherein at least one of the one or more compartments is formed within a body of the one of the ESP components.

9. The ESP system of claim 8, wherein the at least one of the one or more compartments is formed within a stator body of the motor.

10. The ESP system of claim 8, wherein the at least one of the one or more compartments is formed within a motor head of the motor.

11. The ESP system of claim 8, wherein the at least one of the one or more compartments is formed within a wall of a pump body of the pump.

12. An apparatus for reducing vibration in a downhole tool, the apparatus comprising:
a particle damper including:
one or more compartments, each of the compartments in fixed relation to the downhole tool;
each compartment containing a corresponding collection of particles which are capable of freely moving within the compartment.

13. The apparatus of claim 12, wherein the particle damper comprises a stand-alone unit which is secured to an exterior of the downhole tool.

14. The apparatus of claim 12, wherein one or more of the compartments of the particle damper are integrally formed within one or more components of the downhole tool.

15. A method for reducing vibration in a downhole tool, the method comprising:
providing compartments in fixed relation to a component of a downhole tool;
placing particles in the compartments;
sealing the particles in the compartments; and
operating the downhole tool, wherein vibrations in the downhole tool cause movement of the particles within the compartments, the movement of the particles causing damping of the vibrations.

16. The method of claim 15, wherein providing the compartments comprises forming the compartments integrally within the component of the downhole tool and assembling the component into the downhole tool.

17. The method of claim 16, wherein the downhole tool comprises an electric submersible pump (ESP) component.

18. The method of claim 15, further comprising installing the downhole tool in a well prior to operating the downhole tool in the well.

19. The method of claim 15, wherein providing the compartments comprises forming the compartments in a stand-alone particle damper unit, securing the stand-alone particle damper unit to an exterior of the downhole tool.

20. The method of claim 19, wherein the downhole tool comprises an electric submersible pump (ESP) component.
